(19) United States
(12) Patent Application Publication
(10) Pub. No.: US 2019/0355045 A1
(43) Pub. Date: Nov. 21, 2019

(54) SYSTEM AND METHOD FOR PRODUCT DISCOVERY

(71) Applicant: Oneida Consumer, LLC, Columbus, OH (US)

(72) Inventors: Paul Gebhardt, Columbus, OH (US); Jeff Jarrett, Columbus, OH (US); Sarah Landsman, Columbus, OH (US); Charles Ryder, Columbus, OH (US); Juliette Sung, Columbus, OH (US)

(21) Appl. No.: 16/415,080

(22) Filed: May 17, 2019

Related U.S. Application Data
(60) Provisional application No. 62/673,574, filed on May 18, 2018.

(51) Int. Cl. G06Q 30/06; G06N 20/00; G06F 3/0482

(52) U.S. Cl. CPC G06Q 30/0631; G06F 3/0482; G06N 20/00; G06Q 30/0643

(57) ABSTRACT

A product discovery portal provides product recommendations based on user input and visualizations of recommended products that showcase the products within a particular environment or setting. The user input is indicative of one or more characteristics of a user of the products or a desired environment or setting in which the products are to be used. Based on the user input, the product discovery portal selects products or collections of products. The product discovery portal generates a graphical representation by which to visualize the selected products or collections in a suitable environment.

### CROSS-REFERENCE TO RELATED APPLICATIONS

This application claims the benefit of and priority to U.S. Provisional Application No. 62/673,574, filed on May 18, 2018. The entirety of this application is incorporated herein by reference.

### TECHNICAL FIELD

This application relates generally to a product discovery portal and, more particularly, to systems for recommending and visualizing products in a suitable setting.

### BACKGROUND

Product discovery can be a daunting task. In some sectors, there can be numerous configurations and choices available to a consumer. The consumer may possess sufficient knowledge of available products to select a choice with ease. Often, however, the consumer resorts to flipping through a catalog or scrolling through search results looking for ideal products.

In addition to being a time-consuming process, simply viewing images of products may be insufficient to enable the consumer to make a choice. Marketers and advertisers may present products within an example environment. The environment chosen by the marketers/advertisers may not match an environment intended by the consumer. Thus, existing commerce channels often provide a lackluster experience when presentation of a product in a desired setting is an important component of a purchase decision.

### BRIEF SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, a product discovery portal provides a recommendation engine that solicits input from a user (e.g. a prospective purchaser of products) indicative of characteristics of at least one of the user or a proposed environment or setting for products. Based on the indicated characteristics, one or more products or one or more collections of products are identified from a plurality of products or a plurality of collections of products. The product discovery portal generates a graphical representation of an environment or setting for the products. For example, the graphical representation may be based on the characteristics indicated by the input from the user. The graphical representation of the environment may be populated with graphical representations of the one or more products or one or more collections of products identified. The graphical representation is output to the user so as to visualize the products within a suitable environment.

These and other embodiments are described in more detail below.

### BRIEF DESCRIPTION OF THE DRAWING

Various non-limiting embodiments are further described with reference the accompanying drawings in which:

FIG. 1 is a schematic block diagram of an exemplary, non-limiting embodiment of a product discovery portal according to one or more aspects;

FIG. 2 is a schematic block diagram of an exemplary, non-limiting embodiment of a product discovery system including the product discovery portal of FIG. 1;

FIG. 3 is a schematic block diagram of an exemplary, non-limiting embodiment of a client device of the product discovery system of FIG. 2;

FIG. 4 is a schematic block diagram of an exemplary, non-limiting embodiment of a portal device of the product discovery system of FIG. 2;

FIG. 5 is a block diagram representing an exemplary, non-limiting networked environment, such as a cloud or internet-based environment, in which various embodiments described herein can be implemented;

FIG. 6 is a schematic block diagram of an exemplary, non-limiting embodiment of the product discovery portal;

FIG. 7 is an exemplary screenshot of a graphical representation of products in a suitable environment;

FIG. 8 is an exemplary screenshot of a graphical representation of products in a suitable environment;

FIG. 9 is an exemplary screenshot of a graphical representation of products in a suitable environment;

FIG. 10 is a flow diagram of an exemplary, non-limiting embodiment for recommending products; and

FIG. 11 is a flow diagram of an exemplary, non-limiting embodiment for visualizing products in a suitable environment.

### DETAILED DESCRIPTION OF THE INVENTION

As discussed above, existing commercial channels and e-commerce solutions do not maintain a satisfactory product discovery experience in view of expanding choice. It is cumbersome to reduce a set of options to a size that can be reasonably reviewed. Further, visualizing a product in a desired environment may not be possible without first purchasing the product.

In various, non-limiting embodiments, a system and associated methods are provided for product discovery and visualization. A product discovery portal is provided that is accessible by client devices to recommend products based on user input and provide visualizations of the products within a particular environment or setting. For example, the product discovery portal may be a cloud-based or Internet-based software application accessible by client devices via a web browser application or a native application via an application programming interface (API). The product discovery portal may solicit user input from a user (e.g. a prospective customer) via the client device. For instance, a questionnaire or a series of prompts may be output via the client device. The user input received in response to the solicitation may be indicative of one or more characteristics of the user or a desired environment or setting in which products are to be used. Based on the user input, the product discovery portal selects products or collections of products for the user.

The product discovery portal may present the selected products or collections as a list. However, the product discovery portal is further capable of generating a graphical representation by which to visualize the products or collections in a suitable environment. For instance, a graphical representation of the suitable environment may be generated based on the user input. In addition, the user may provide a photograph of a setting which is adapted to create the graphical representation. Within the graphical representation of the environment, graphical representations (e.g. 3D models) of the products may be introduced so as to showcase the products within the environment. The graphical representation may be output to the user via the client device and may be interactive. For example, the user may zoom, pan, rotate, and traverse the environment. The product discovery portal may interface or include an ordering subsystem by which the user may purchase a product or collection after experiencing the graphical representation of the environment.

According to one example, the product discovery portal may be employed for products utilized in a dining environment. In operating a dining establishment, quality of the food is a chief concern. However, presentation of the food is also an important aspect. Presentation includes the dining products utilized to serve the food such as, for example, dinnerware, plateware, flatware, glassware, and other tabletop items. Such products may be organized into collections. A collection may include, for example, various plates having different sizes, bowls, flatware (e.g. spoons, knives, forks), glassware (e.g. wine glasses, water glasses, cocktail glasses, beer glasses, etc.), and other tabletop items such as napkins, mugs, cups, dishes, or the like. A collection, more particularly, is a group of items such as those iterated above having a common theme or shared feature. In other words, a collection is a set of products having a natural or designed pairing such that using the products together does not present a disjointed or mismatched experience.

In this example involving a dining environment and dining-related products, a questionnaire may be presented to the user to solicit input regarding characteristics of the restaurant (e.g. style, atmosphere), characteristics of typical diners, characteristics of the food (e.g. cuisine), desired physical characteristics of products, or the like. An exemplary question may ask what image best represents a restaurant or dining area interior design and the question may have possible answers such as class, modern, decorative, or artisan. Another question may request input on typical guest characteristics. For example, possible answers may include family, romantic couple, sports fan, colleagues, hipsters, college students, regal elderly, wine connoisseur, organic food enthusiast, health-focused foodie, etc. Another question may involve a description of a typical guest experience with possible answers including fine dining, casual dining, communal dining, table with shared plates, bar with small plates, happy hour with cocktails, birthday celebrations, meetings, garden brunch, wine tasting, beer tasting, etc. The questionnaire may also seek input on a primary type of cuisine for which the user input may specify seafood, sushi, steak, Asian, comfort food, BBQ, French bistro, diner, Mexican, small plates/tapas, bar and grill or tavern food, café or coffee shop, Italian/pizza, vegetarian, Mediterranean, American, etc. The questionnaire may also solicit input regarding preferences for physical properties of the products. For instance, the user input may indicate a preference for durable products or a preference for products having a finer quality feel.

The product discovery portal may select a collection or a set of products based on the user input. The collection may include products (e.g. dinnerware, flatware, glassware, etc.) appropriate for the dining environment or setting indicated by the user input. The selection may be score-based. Each product or collection may have a corresponding score for each characteristic specified in the user input. For instance, each product or collection may have a score assigned that rates how appropriate the product or collection is for Mediterranean cuisine, a score assigned for a casual dining environment, a score assigned for guests primarily comprised of families, etc. For each product or collection, corresponding scores across each characteristics indicated in the user input are summed. The product or collection with the highest score is collected. In another aspect, any product or collection having a summed score greater than a threshold is selected.

In another aspect, machine learning techniques may be employed to facilitate selection of products or collections. For example, characteristics of a customer, such as those enumerated above, may be associated with products or collections viewed or purchased by the customer. Training data constructed as such may be employed to build a machine learning system capable of recommending products to subsequent customers based on corresponding user input.

When products (or collections) are selected, a graphical representation may be generated to showcase the selected products. The graphical representation may be a virtual dining environment (e.g. a 3D model of a dining environment) having characteristics similar to those indicated in the user input. Further, graphical representations (e.g. 3D models) of the selected products can be included in the virtual dining environment in a place setting, for example. The customer may interact with the virtual dining environment to zoom, pan, rotate a view, and/or manipulate objects in the virtual dining environment to experience how the products may appear in suitable proxy for a real environment prior to purchase.

In accordance with one embodiment, a system is provides that includes a processor, a communication interface for communication with clients, and a computer-readable storage medium. The computer-readable storage medium stores instructions for a product discovery portal. When executed, the instructions configure the processor to receive user input via the communication interface, the user input indicative of characteristics relative to types of products discoverable via the product discovery portal; identify one or more products from a set of products based on the characteristics indicated by the user input; generate a graphical representation of an environment including the one or more products showcased within a suitable setting for the one or more products; and output the graphical representation to the user via the communication interface.

According to various examples, the processor is further configured to output a prompt to the user via the client device, wherein the user input is received in response to the prompt. The prompt is a questionnaire. The processor is further configured to utilize a score-based selection of products, wherein a product has a corresponding score for a characteristic and scores are summed across the characteristics indicated in the user input. The processor is further configured to select products having a summed score greater than a threshold to identify the one or more products form the set of products.

In another example, the processor is further configured to utilize machine learning to build a correspondence between characteristics and products from the set of products. For instance, the processor is further configured to train a machine learning model based on user input from other users and products purchased by the other users.

Still further, the processor is further configured to receive graphical models of the set of products and insert the graphical models into the graphical environment to showcase the one or more products in the suitable setting. The one or more products include glassware, dinnerware, and flatware. The graphical representation is a place setting in a dining environment.

In another embodiment, a method is provided. The method includes receiving information indicative of characteristics of an environment in which products from a set of products are utilized. The method also includes selecting one or more products from the set of products based on the characteristics indicated by the received information. Further, the method includes generating a graphical representation of the environment with graphical representations of the one or more products selected included in the environment. In addition, the method includes displaying the graphical representation.

According to examples, wherein the information indicative of characteristics of the environment is received in response to a questionnaire. The method also includes tallying scores for products of the set of products based on the information indicative of the characteristics, wherein a product has a corresponding score for a characteristic indicated in the information. In addition, the method can include selecting the one or more products includes selecting products having a summed score greater than a threshold. The set of products include glassware, dinnerware, and flatware. The environment is a dining environment and the graphical representation includes a place setting of the one or more products.

In yet another embodiment, a non-transitory, computer-readable medium having stored thereon computer-executable instructions for a product discovery portal is provided. The computer-executable instructions, when executed by a processor, configure the processor to: receive user input from a client device, the user input specifies characteristics of a dining environment; select a collection from a plurality of collections based on the characteristics specified by the user input, wherein the collection includes a dinnerware product, a flatware product, and a glassware product; generate a graphical representation of the dining environment with a place setting including graphical representations of the collection selected; and output the graphical representation of the dining environment with the place setting to the user via the client device.

In various examples, the instructions further configure the processor to output a questionnaire to the user via the client device, wherein the user input is received in response to the questionnaire. The instructions can further configure the processor to select the collection based on scores for the plurality of collections, wherein a collection of the plurality of collections has a corresponding score for a characteristic specified by the user input and scores are tallied across the characteristics specified by the user input. In addition, the instructions can configure the processor to utilize a machine learning model that is trained to provide a correspondence between characteristics of a dining environment and the plurality of collections.

An overview of some embodiments of a product discovery portal has been presented above. As a roadmap for what follows next, product discovery portal is generally described in more detail. The above noted features and embodiments will be described with reference to the drawings, wherein like reference numerals are used to refer to like elements throughout.

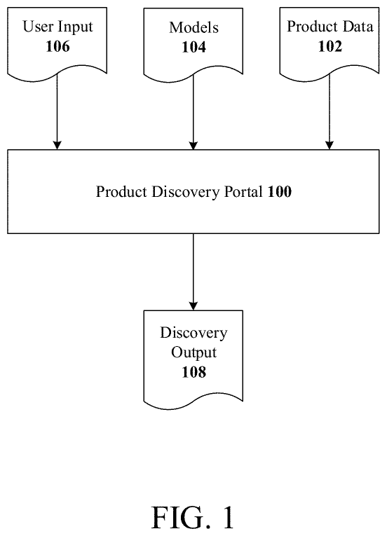

FIG. 1 shows a schematic block diagram of an exemplary, non-limiting embodiment of a product discovery portal 100. The product discovery portal 100 receives user input 106, which is indicative of characteristics of the user of products, characteristics of a desired environment or setting for products, product preferences, or the like. The product discovery portal 100 generates discovery output 108 based at least in part on the user input 106. The discovery output 108 may be a listing of products recommended based on the user input 106. In another aspect, the discovery output 108 may be a graphical representation of an environment (e.g. a virtual environment) in which the products are typically utilized. Within the virtual environment, graphical representations of products selected by the product discovery portal 100 may be showcased.

The product discovery portal 100 is extensible and configurable. For instance, products can be added to the system and/or the manner in which products are recommended based on user input 106 can be changed. To do so, models 104 and product data 102 can be input to the product discovery portal 100. Models 104 may be, for example, 3D models of products that can be incorporated into the virtual environment generated by the product discovery portal 100. Product data 102 can include product information (e.g. names, descriptions, etc.) for the products as well as other data relevant for product matching. For instance, for a given product, the other data may include properties of that product and a correspondence of that product to characteristics specified in the user input 106. This data may include metrics on how well the product matches the characteristic values in the user input 106. Accordingly, the product data 102 provides a basis by which a product may be scored against user input 106 to judge how well the product matches overall with the characteristics indicated in user input 106. In one example, each product in a set of products can be scored by tallying corresponding metrics (e.g. scores) provided in product data 102 for each characteristic value specified in user input 106. The summed scores can be utilized to select products to include in discovery output 108. The products selected may have the highest score or scores greater than a predetermined threshold.

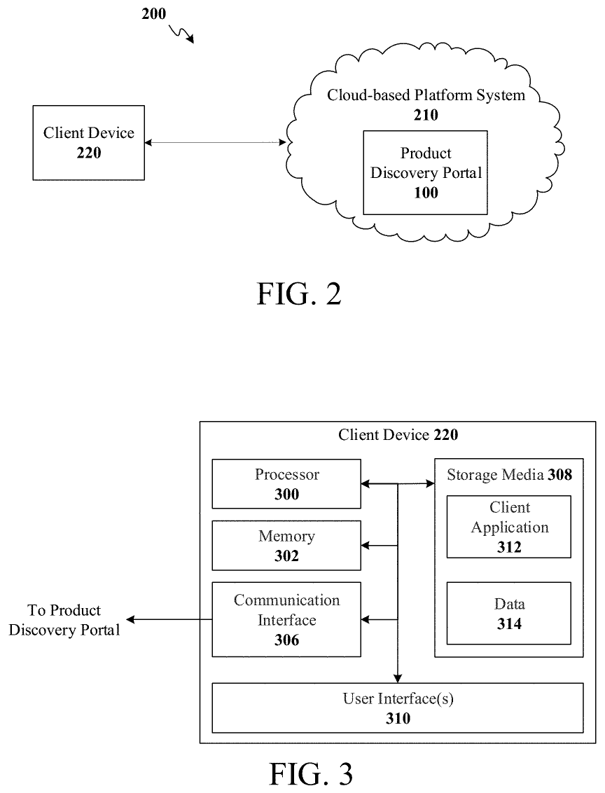

FIG. 2 is a schematic block diagram of an exemplary, non-limiting embodiment of a product discovery system 200 including the product discovery portal 100. As shown in FIG. 2, the system 200 can include a cloud-based platform 210 on which the product discovery portal 100 is implemented. A client device 220 may communication with the product discovery portal 100 via the Internet or other communication network.

FIG. 3 illustrates a schematic block diagram of an exemplary, non-limiting embodiment of client device 220. Client device 160 includes one or more processor(s) 300 configured to execute computer-executable instructions such as instructions composing a client application 312. Such computer-executable instructions can be stored on one or more computer-readable media including non-transitory, computer-readable storage media such as memory 302 or storage 308. For instance, storage 308 can include non-volatile storage to persistently store client application 312 and/or data 314. Memory 302 can also include volatile storage that stores instructions, other data (working data or variables), or portions thereof during execution of client application 312 by processor 300. Client application 312 may be a web browser application or a native application configured to access the product discovery portal 100 via an API.

Client device 220 further includes a communication interface 306 to couple client device 220, via the Internet or other communications network, to the product discovery portal 100. Communication interface 306 can be a wired or wireless interface including, but not limited, a WiFi interface, an Ethernet interface, a Bluetooth interface, a fiber optic interface, a cellular radio interface, a satellite interface, etc. Client device 220 can further include a user interface 310 that comprises various elements to obtain user input and to convey user output. For instance, user interface 310 can comprise of a touch display which operates as both an input device and an output device. In addition, user interface 310 can also include various buttons, switches, keys, etc. by which a user can input information to client device 220; and other displays, LED indicators, etc. by which other information can be output to the user. Further still, user interface 310 can include input devices such as keyboards, pointing devices, and standalone displays.

In accordance with an embodiment, client device 220 is a computing device, which is readily carried by a user, such a smartphone or tablet device. However, it is to be appreciated that client device 220 can be other portable form-factors such as a laptop computer, a convertible laptop, a watch computing device, or the like. Moreover, client device 220 can be a desktop computer, or other larger, less portable computing device. That is, client application 312 can be installed and executed on substantially any computing device provided that such a computing device can communicate with the product discovery portal 100 as described herein.

The client application 312 configures the client device 220 to receive information from the product discovery portal 100 such as user prompts or questionnaires as described herein, discovery output 108 (e.g. graphical representations), or other information. The client application 312 further configures the client device 220 to transmit information to the product discovery portal 100 such as user input 106 indicative of characteristics of the users, desired environments, and/or desired product properties. The client application 312 outputs a graphical user interface that enables a user to display the prompts and graphical representations of the products and product environment. The client application 312 can obtain user input via the user interface 410 and in accordance with the graphical user interface.

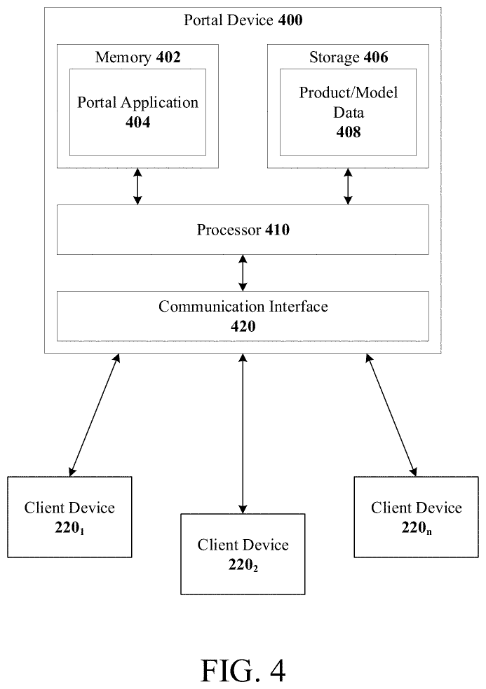

Referring to FIG. 4, an exemplary, non-limiting embodiment of a portal device 400 is illustrated. Portal device 400 is a generalized representation of a computing device such as a server, available via cloud-based platform 210, on which the product discovery portal 100 can be implemented. As shown in FIG. 4, portal device 400 includes one or more processor(s) 410 configured to execute computer-executable instructions such as instructions composing a portal application 404 to implement product discovery as described herein. Such computer-executable instructions can be stored on one or more computer-readable media including non-transitory, computer-readable storage media such as memory 402 or storage 406. For instance, storage 406 can include non-volatile storage to persistently store instructions 404 and/or product/model data 408 (e.g., 3D product models, matching metric values, product descriptions, product names, etc.). Memory 402 can also include volatile storage that stores instructions 404, other data (working data or variables), or portions thereof during execution by processor 410.

Portal device 400 further includes a communication interface 420 to couple portal device 400, via the Internet or other communications network, to client devices 220. Communication interface 420 can be a wired or wireless interface including, but not limited, a WiFi interface, an Ethernet interface, a Bluetooth interface, a fiber optic interface, a cellular radio interface, a satellite interface, etc. As shown in FIG. 4, portal device 400 can service a plurality of client devices 220, which include client device 220₁, client device 220₂, . . . , client device 220ₙ, where n is an integer greater than or equal to one.

One of ordinary skill in the art can appreciate that the various embodiments of a product discovery system described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the well management system can be implemented based on such a cloud environment. For example, product discovery portal 100 can reside in the cloud environment such that the computer-executable instruction implementing the functionality thereof are executed with the aggregated computing resources provided by the plurality of physical computing devices. The cloud environment provides one or more methods of access to the product discovery portal 100, which are utilized by client application 312 on client device 220. These methods of access include IP addresses, domain names, URIs, etc. Since the aggregated computing resources can be provided by physical computing device remotely located from one another, the cloud environment can include additional devices such as a routers, load balancers, switches, etc., that appropriately coordinate network data.

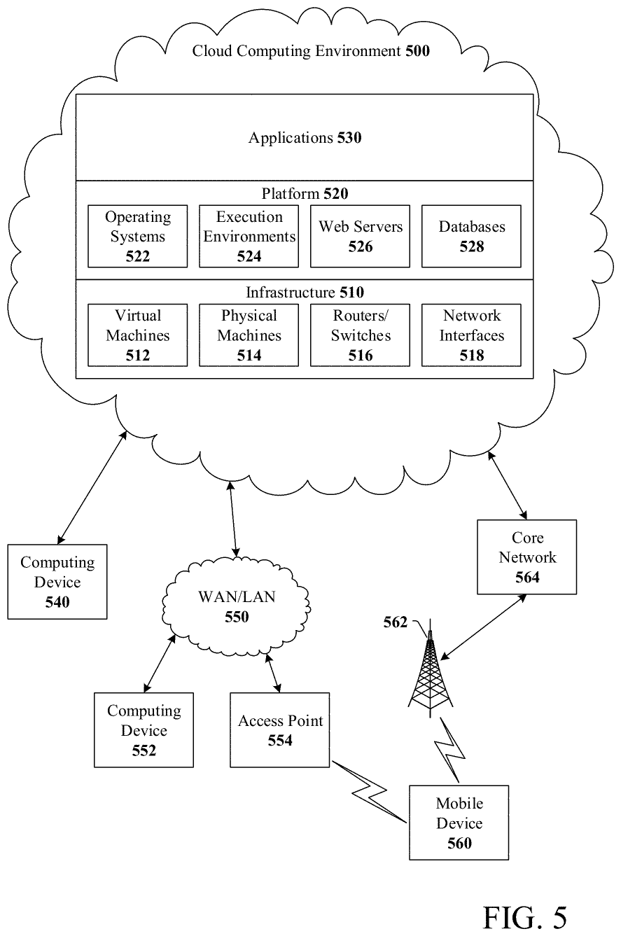

FIG. 5 provides a schematic diagram of an exemplary networked or distributed computing environment, such as a cloud computing environment 500. The cloud computing environment 500 may be one embodiment of cloud-based platform 210 on which the product discovery portal 100 is implemented. The cloud computing environment 500 represents a collection of computing resources available, typically via the Internet, to one or more client devices. The cloud computing environment 500 comprises various levels of abstraction: infrastructure 510, a platform 520, and applications 530. Each level, from infrastructure 510 to applications 530 is generally implemented on top of lower levels, with infrastructure 510 representing the lowest level.

Infrastructure 510 generally encompasses the physical resources and components on which cloud services are deployed. For instance, infrastructure 510 can include virtual machines 512, physical machines 514, routers/switches 516, and network interfaces 518. The network interfaces 518 provide access to the cloud computing environment 500, via the Internet or other network, from client devices such as computing devices 540, 552, 560, etc. That is, network interfaces 518 provide an outermost boundary of cloud computing environment 500 and couple the cloud computing environment 500 to other networks, the Internet, and client computing devices. Routers/switches 516 couple the network interfaces 518 to physical machines 514, which are computing devices comprising computer processors, memory, mass storage devices, etc. Hardware of physical machines 514 can be virtualized to provide virtual machines 512. In an aspect, virtual machines 512 can be executed on one or more physical machines 514. That is, one physical machine 514 can include a plurality of virtual machines 512.

Implemented on infrastructure 510, platform 520 includes software that forming a foundation for applications 530. The software forming platform 520 includes operating systems 522, programming or execution environments 524, web servers 526, and databases 528. The software of platform 520 can be installed on virtual machines 512 and/or physical machines 514.

Applications 530 include user-facing software applications, implemented on platform 520, that provide services to various client devices. In this regard, the backend system 150 of the well management system 100 described herein is an example application 530. As illustrated in FIG. 5, client devices can include computing devices 540, 552 and mobile device 560. Computing devices 540, 552 can be directly coupled to the Internet, and therefore the cloud computing environment 500, or indirectly coupled to the Internet via a WAN/LAN 550. The WAN/LAN 550 can include an access point 554 that enables wireless communications (e.g., WiFi) with mobile device 560. In this regard, via access point 554 and WAN/LAN 550, mobile device 560 can communicate wirelessly with the cloud computing environment 500. Mobile device 560 can also wirelessly communicate according to cellular technology such as, but not limited to, GSM, LTE, WiMAX, HSPA, etc. Accordingly, mobile device 560 can wirelessly communicate with a base station 562, which is coupled to a core network 564 of a wireless communication provider. The core network 564 includes a gateway to the Internet and, via the Internet, provides a communication path to the cloud computing environment 500.

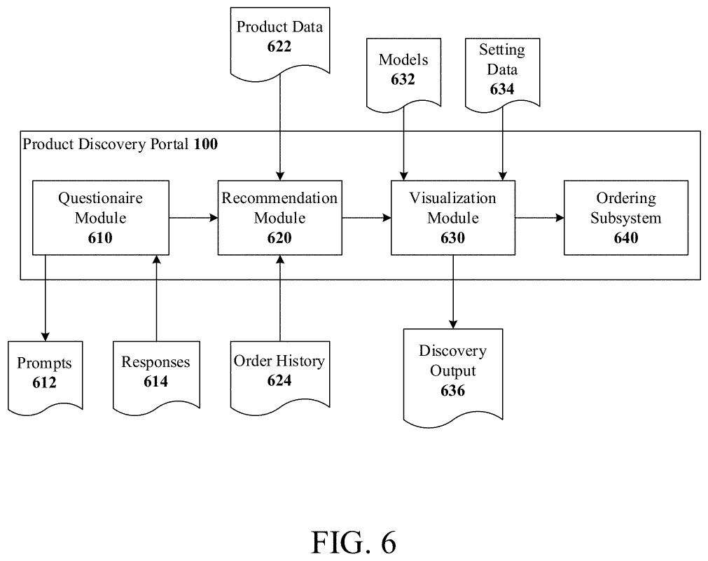

Turning now to FIG. 6, illustrated is a schematic block diagram of an exemplary, non-limiting embodiment of product discovery portal 100 according to various aspects. As described above, product discovery portal 100 may be implemented on a cloud-based platform such as the cloud environment described in FIG. 5, or a server computing device such as portal device 400 from FIG. 4. Though not shown in FIG. 6, input to and output from product discovery portal 100 typical involves a client device such as client device 220 described above.

A shown in FIG. 6, the product discovery portal 100 includes a questionnaire module 610 configured to solicit user input indicative of characteristics related to types of products discoverable via the product discovery portal 100. The questionnaire module 610 can output prompts 612 to a user and receive responses 614. For example, within dining products used in a dining environment, prompts 612 can request information regarding a type of cuisine, a type of restaurant décor, characteristics of typical guests, type of guest experience, etc. In turn, responses 614 can indicate specific values for those prompts. For instance, responses 614 can indicate a fine dining experience serving French cuisine primarily enjoyed by romantic couples.

Characteristics indicated in responses 614 can be provided to a recommendation module 620 to identify matching products. According to one aspect, recommendation module 620 can select products based on product data 622 which includes metrics regarding a particular product's match to various characteristics. For instance, the product data 622 may include respective scores for products for the characteristics. In the example above, for a particular collection (e.g. collection including dinnerware, flatware, and/or glassware), product data 622 may include a score regarding the collection's match with French cuisine, a score indicating an appropriateness of the collection for fine dining, and/or a score related to suitability for romantic couples. Recommendation module 620 can sum individual scores per characteristics for products and select a product (or collection) having the highest score. The recommendation module 620 may select more than one product or collection. For instance, recommendation module 620 may select any product or collection having a summed total greater than a predetermined threshold.

According to another aspect, recommendation module 620 can utilize a machine learning system to select products based on characteristics indicated in user input. For instance, order history 624 can be combined with characteristics supplied by previous purchasers to train a machine learning model. The trained model can subsequently select products based on supplied characteristics from later users.

The products or collections selected by the recommendation module 620 can be provided to visualization module 630 that generates discovery output 636. In one embodiment, discovery output 636 is a graphical representation of a suitable environment for the products in which graphical representations of the selected products are showcased. The visualization module 630 can received models 632 and setting data 634 as input. The models 632 may include 3D graphical models of the products and setting data 634 may include 3D models of a virtual environment or setting along with information regarding the arrangements of the products in the virtual environment. In another example, the setting data 634 may include a picture of a real environment in which graphical representations of the products are inserted. The product discovery portal 100 may further include an ordering subsystem 640 to facilitate purchasing of products selected by the recommendation module 620 and/or graphically rendered by the visualization module 630.

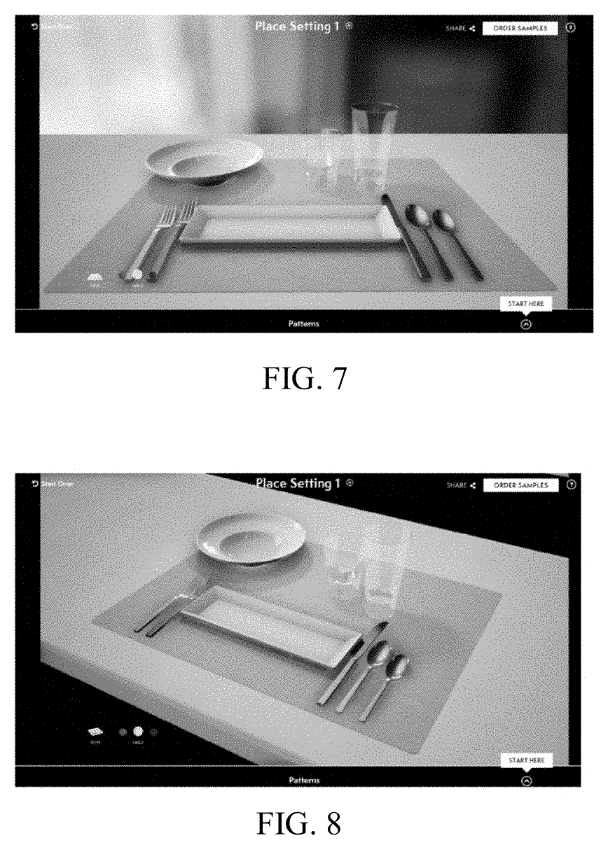

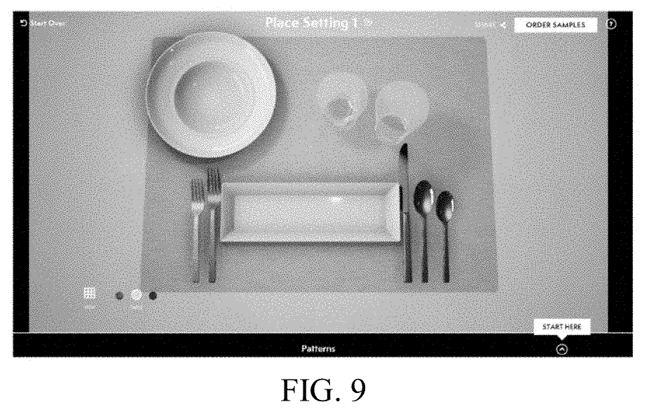

Turning now to FIGS. 7-9, exemplary graphical representations generated by product discovery portal 100 are depicted. FIGS. 7-9 depict place settings of dining products in a dining environment.

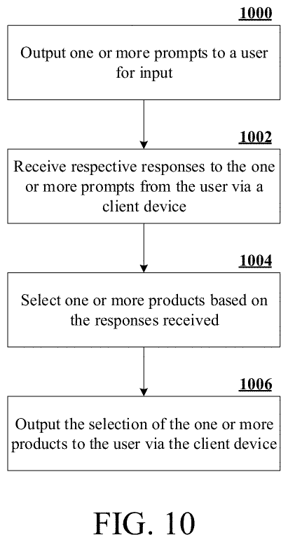

Referring now to FIG. 10, illustrated is a flow diagram of a method for recommending products. Method 500 can be implemented, for example, by product discovery portal 100 described above. At 1000, one or more prompts are output to a user to solicit input. The one or more prompts may be questions seeking input regarding characteristics of the user, characteristics of a proposed environment or setting for products, preferred properties of products, etc. For example, in the case of a dining products, the one or more prompts may solicit input regarding a type of cuisine, a type of diner, a décor of a dining establishment, a type of experience provided by the dining establishment, preferred properties of the dining products, or the like.

At 1002, the product discovery portal receives, from the user via a client device, respective responses to the one or more prompts. In the above example, the responses may indicate a fine dining experience with French cuisine primarily enjoyed by romantic couples, for instance. At 1004, one or more products are selected based on the responses received. For example, the products may be selected using a score-based approach as described above and/or with machine learning. At 1006, the selection of one or more products is output to the user via the client device.

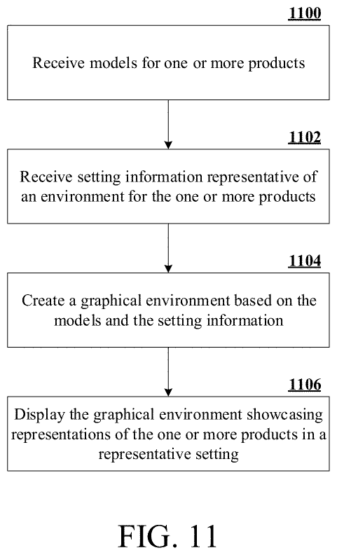

Turning now to FIG. 11, a flow diagram for an exemplary method for visualizing products in a suitable environment. According to an aspect, the product discovery portal can output the selection of one or more products in accordance with this method. At 1100, models of one or more products are received. For instance, the models may be 3D models or other graphical representations of the one or more products. At 1102, setting information is received. The setting information is representative of an environment for the one or more products. The setting information may include 3D models of a virtual environment or a photograph of a real environment. At 1104, a graphical representation is created based on the models and the setting information. At 1106, the graphical representation showcasing representations of the one or more products in a representative setting is displayed. As mentioned above, FIG. 7-9 depicts exemplary graphical representations in the context of a dining products in an dining environment.

As mentioned above, while exemplary embodiments have been described in connection with various computing devices and network architectures, the underlying concepts may be applied to any network system and any computing device or system in which it is desirable to implement an image segmentation system.

Also, there are multiple ways to implement the same or similar functionality, e.g., an appropriate API, tool kit, driver code, operating system, control, standalone or downloadable software objects, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the term “exemplary” is intended to mean “serving as an illustration or example of something.”

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor;
a communication interface for communication with clients; and
a computer-readable storage medium storing computer-executable instructions for a product discovery portal that, when executed by the processor, configure the processor to:
receive user input via the communication interface, the user input indicative of characteristics relative to types of products discoverable via the product discovery portal;
identify one or more products from a set of products based on the characteristics indicated by the user input;
generate a graphical representation of an environment including the one or more products showcased within a suitable setting for the one or more products; and
output the graphical representation to the user via the communication interface.

2. The system of claim 1, wherein the processor is further configured to output a prompt to the user via the client device, wherein the user input is received in response to the prompt.

3. The system of claim 2, wherein the prompt is a questionnaire.

4. The system of claim 1, wherein the processor is further configured to utilize a score-based selection of products, wherein a product has a corresponding score for a characteristic and scores are summed across the characteristics indicated in the user input.

5. The system of claim 4, wherein the processor is further configured to select products having a summed score greater than a threshold to identify the one or more products form the set of products.

6. The system of claim 1, wherein the processor is further configured to utilize machine learning to build a correspondence between characteristics and products from the set of products.

7. The system of claim 6, wherein the processor is further configured to train a machine learning model based on user input from other users and products purchased by the other users.

8. The system of claim 1, wherein the processor is further configured to receive graphical models of the set of products and insert the graphical models into the graphical environment to showcase the one or more products in the suitable setting.

9. The system of claim 1, wherein the one or more products include glassware, dinnerware, and flatware.

10. The system of claim 9, wherein the graphical representation is a place setting in a dining environment.

11. A method, comprising:
receiving information indicative of characteristics of an environment in which products from a set of products are utilized;
selecting one or more products from the set of products based on the characteristics indicated by the received information;
generating a graphical representation of the environment with graphical representations of the one or more products selected included in the environment; and
displaying the graphical representation.

12. The method of claim 11, wherein the information indicative of characteristics of the environment is received in response to a questionnaire.

13. The method of claim 11, further comprising tallying scores for products of the set of products based on the information indicative of the characteristics, wherein a product has a corresponding score for a characteristic indicated in the information.

14. The method of claim 13, wherein selecting the one or more products includes selecting products having a summed score greater than a threshold.

15. The method of claim 11, wherein the set of products include glassware, dinnerware, and flatware.

16. The method of claim 15, wherein the environment is a dining environment and the graphical representation includes a place setting of the one or more products.

17. A non-transitory, computer-readable medium having stored thereon computer-executable instructions for a product discovery portal, the computer-executable instructions, when executed by a processor, configure the processor to:
receive user input from a client device, the user input specifies characteristics of a dining environment;
select a collection from a plurality of collections based on the characteristics specified by the user input, wherein the collection includes a dinnerware product, a flatware product, and a glassware product;
generate a graphical representation of the dining environment with a place setting including graphical representations of the collection selected; and
output the graphical representation of the dining environment with the place setting to the user via the client device.

18. The non-transitory, computer-readable medium of claim 17, further storing computer-executable instructions that configure the processor to output a questionnaire to the user via the client device, wherein the user input is received in response to the questionnaire.

19. The non-transitory, computer-readable medium of claim 17, further storing computer-executable instructions that configure the processor to select the collection based on scores for the plurality of collections, wherein a collection of the plurality of collections has a corresponding score for a characteristic specified by the user input and scores are tallied across the characteristics specified by the user input.

20. The non-transitory, computer-readable medium of claim 17, further storing computer-executable instructions that configure the processor to utilize a machine learning model that is trained to provide a correspondence between characteristics of a dining environment and the plurality of collections.
